(19) United States
(12) Patent Application Publication
(10) Pub. No.: US 2011/0055036 A1
(43) Pub. Date: Mar. 3, 2011

(54) METHODS AND SYSTEMS FOR MANAGING ELECTRICITY DELIVERY AND COMMERCE

(75) Inventor: Ron HELFAN, Tel-Aviv (IL)

(73) Assignee: Meishar Immediate Community, Herzlia (IL)

(21) Appl. No.: 12/844,893

(22) Filed: Jul. 28, 2010

Related U.S. Application Data
(60) Provisional application No. 61/239,471, filed on Sep. 3, 2009.

(51) Int. Cl. G06Q 30/00; H01M 10/46; G06F 1/28

(52) U.S. Cl. 705/26.1; 320/101; 700/291

(57) ABSTRACT

Methods and systems of managing electric energy delivery and/or commerce. One of the methods comprises providing a plurality of power sell offers of a plurality of first consumers each connected to an electric grid, providing a power purchase offer of a second consumer connected to the electric grid, selecting at least one of the plurality of sell offers of at least one of the plurality of first consumers according to the power purchase offer, and billing the second consumer according to the at least one selected sell offer so at to allow crediting the at least one first consumer.

### RELATED APPLICATION/S

This application claims the benefit of priority under 35 USC 119(e) of U.S. Provisional Patent Application No. 61/239,471 filed Sep. 3, 2009, the contents of which are incorporated herein by reference in their entirety.

### FIELD AND BACKGROUND OF THE INVENTION

The present invention, in some embodiments thereof, relates to method and system for managing resources and, more particularly, but not exclusively, to method and system for managing power supply and consumption.

During the last decade, various electric energy markets adapted an electric energy policy for consumers who own renewable energy sources, such as wind, solar power or home fuel cells. This has been a result of the increasing environmental awareness and the adoption of the Kyoto Protocol for reduction of Green House Gasses emissions. Examples for such electric energy policy include Net Metering, feed in tariffs (FIT) and tax crediting. FIT and Net Metering may be defined by local laws and regulations in several ways and formulas which vary between territories and/or utilities.

Such electric energy policies offer incentives such as electric billing deductions or preferred rates for the generated and/or distributed energy.

The integration of renewable sources has given rise to distributed Generation in which energy is not generated at a centralized location, such as a power station, but rather generated at various locations throughout a grid, for example by residential and commercial rooftop photovoltaic (PV) installations, wind turbines, wind farms, solar farms and the like. These renewable installations are located at the consumer's back yard or roof. Larger renewable energy installations, known as energy farms, are usually located where natural resources, solar irradiation and wind regimes, are available and abundant.

Energy generated from the distributed renewable sources may be delivered to the main utility grid, consumed locally or stored for future consumption.

Some electric grid consumers are monitored by smart meters. Such smart meters may be used to establish advanced metering infrastructure (AMI) and automated metering reading (AMR) capacities that offer benefits to both users and utility companies, such as cost reductions via automated billing, informed consumerism, peak load management and demand response programs. Current and foreseeable storage solutions, such as battery sets, are not common due to relatively short life cycles, high prices, energy losses, and use of hazardous and/or toxic materials, such as lead and lithium.

It should be noted that the incentives currently available may soon become a derivative determined by supply and demand, in the same manner that utility rates are becoming dynamic, i.e. dependent upon the relationship between supply and demand (may also be referred as “Real Time Pricing”. For example, the utility rate and FIT in a very hot day, when the average current consumption, would be higher than the utility rate and FIT in a cool night when the average current consumption is low.

In order to allow billing data logging, transmission and monitoring smart electrometers are used. These smart electrometers record inflow and outflow of electric energy and are usually equipped with two-way communications to allow remote data transmission for billing and diagnostics and also remote notifications and programs regarding load management and control at the user's end.

Few methods and system have been developed for managing power supply. For example U.S. Pat. No. 5,894,422 that describes a smart meter/billing system that eases the transition to commodity-like marketplace operations for electric power, and supports near real-time load balancing between competing suppliers of electric power. Existing watt-hour meters become multi-parameter terminals or smart meters that measure consumption per unit of time correlatible to calendar-time, measure near real-time demand, measure reliability, store information and transmitting it to a smart meter reader when properly interrogated. The smart reader periodically sends its accumulated information to a billing computer. An optional ancillary system uses the same smart meters to support automatic load balancing between competing suppliers that share common distribution facilities. Supplier designated demand increments from possibly millions of consumers, are summed according to the supplier-of-record, over near real-time intervals. These sums are used by the suppliers to adjust their output power so it equals the actual, near real-time demand of their customers-of-record at any time.

Another example is found in U.S. Pat. No. 7,430,545 that describes a system that is designed to monitor supply and demand electric power between an electric power supplier and a node or a group of nodes individually having an electric power generator. The system provides an electric power supply and demand management system capable of obtaining the difference between the total of electric power supplied from the electric power supplier to the node or group and the total of electric power consumed by the electric power loads of the node or group and capable of transmitting information for increasing/decreasing the amount of electric power supply so that the difference becomes smaller to the electric power supplier.

### SUMMARY OF THE INVENTION

According to some embodiments of the present invention there is provided a method of billing electric energy commerce. The method comprises a) providing a plurality of power sell offers of a plurality of first consumers each connected to an electric grid, b) providing a power purchase offer of a second consumer connected to the electric grid, c) selecting at least one of the plurality of sell offers of at least one of the plurality of first consumers according to the power purchase offer, and d) billing the second consumer according to the at least one selected sell offer so as to allow crediting the at least one first consumer.

Optionally, the method further comprises estimating a distance the second consumer and each the first consumer and performing the selecting according to the distance.

Optionally, the plurality of power sell offers and the power purchase offer are received as network messages sent over a communication network from the plurality of first consumers and the second consumers, the selecting being performed by at least one of a central network node connected to the network, at least one of the plurality of first and second consumers.

Optionally, the each the power supply offer defines a first set of variables comprising a power supply rate, a power supply amount, and a power supply period, the power purchase offer defining a second set of variables comprising a power demand rate, a power demand amount, and a power demand period, the selecting being performed by respectively matching the first and second sets of variables.

Optionally, the power purchase offer is for a future consumption of electric energy.

Optionally, at least one of the plurality of power sell offers is for a future consumption of electric energy.

Optionally, the method further comprises profiling at least one of electricity generation, electricity consumption and electricity storage of at least one of the plurality of first consumers.

Optionally, the selecting further comprises selecting between the plurality of sell offers and at least one utility, the billing being performed according to the selecting.

Optionally, the selecting is performed according to a rate defined in each the power supply sell offer, the a)-c) being repeatedly performed so as to reduce an average rate of the at least one selected sell offer.

Optionally, at least one of the power purchase offer and the power sell offers of at least one of the first and second consumers includes a carbon credit, the selecting comprising trading the carbon credit.

According to some embodiments of the present invention there is provided a method of delivering electric energy. The method comprises generating electric energy using at least one energy source managed by a consumer connected to an electric grid, calculating the amount of energy which is forecasted to be generated in a period of time, calculating a rate for selling the electric energy to another consumer or utility connected to the electric grid, receiving a purchase offer for the electric energy, and selecting between local consumption of the electric energy by the consumer and a delivery of the electric energy to the electric grid according to the purchase offer.

Optionally, the local consumption comprises at least one of charging at least one energy cell, charging a car, and powering a local electric energy network of the consumer.

Optionally, the calculating comprises creating at least one power supply sell offer for at least a portion of the electric energy according to the rate and receiving the purchase offer in response to the at least one power supply sell offer.

More optionally, the creating comprises forwarding the at least one power supply sell offer to at least one of the another consumer and a utility.

Optionally, the method further comprises presenting the purchase offer to a user and receiving a user reaction in response, and performing the selecting according to the user reaction.

Optionally, the method further comprises crediting the consumer for the electric energy according to the rate.

Optionally, the calculating is performed according to metrological and/or weather estimation.

According to some embodiments of the present invention there is provided an electric commerce device connected to an electric grid. The electric commerce device comprises a metering unit for metering electric energy generated by at least one renewable energy source managed by a consumer connected to an electric grid, a controller for generating at least one power supply sell offer for at least a portion of the electric energy, a communication interface for forwarding the at least one power supply sell offer and receiving a reaction thereto, and at least one switch for delivering the portion to the electric grid according to the reaction.

Optionally, the controller is configured for analyzing the reaction and instructing the at least one switch to perform the delivering accordingly.

Optionally, the electric commerce device further comprises a user interface for allowing a user to define the at least one power supply sell offer. Optionally, the controller receives at least one member of a group consisting of a weather estimation, an energy power supply estimation, an energy power demand estimation, a forecasted renewable energy related factor, a set of rules, a projected cost of the delivery, a statistical analysis, a history of previous purchases of electric energy, a current energy rate, a forecasted energy rate, an actual consumption of the consumer, and an estimated consumption of the consumer, an actual carbon footprint of the consumer, an estimated carbon footprint of the, a budget for consumption, a pre-payment option.

Optionally, the electric commerce device further comprises at least one energy storage cell connected to the at least one switch, wherein the controller is configured for instructing the at least one switch to charge or discharge the at least one energy cell according to the reaction.

Optionally, the electric commerce device further comprises at least one charging plug connected to the at least one switch and configured for being in an electrical connection with a rechargeable apparatus, wherein the controller is configured for instructing the at least one switch to power the charging plug according to the reaction so as to allow charging the rechargeable apparatus.

More optionally, the controller is configured for instructing the charging plug to receive charged electricity from the rechargeable apparatus according to the reaction.

According to some embodiments of the present invention there is provided a system of billing electric energy consumption. The system comprises a communication interface for receiving a plurality of power sell offers and power purchase offers from a plurality of consumers connected to an electric grid, a matching unit configured for identifying at least one match between at least one of the plurality of power purchase offers and at least one of the plurality of power sell offers, and a billing unit for billing the plurality of consumers according to the at least one match.

Optionally, the system further comprises a communications interface for transmitting data pertaining to the match to a power supplier.

According to some embodiments of the present invention there is provided a system of billing electric energy commerce. The system comprises a plurality of electricity commerce devices each having a metering unit for outputting a measurement of at least one of electric energy production and electric energy consumption of one of a plurality of consumers, the plurality of electricity commerce devices being configured for generating a plurality of power sell offers and power purchase offers each according to a respective the measurement and forwarding the plurality of power sell offers and power purchase offers among one another over a communication network and a billing unit for billing and crediting the plurality of consumers according to acceptance of the plurality of power sell offers and power purchase offers by at least one of the plurality of consumers.

Optionally, the system further comprises a data analysis unit for analyzing the plurality of power sell offers and power purchase offers and estimating accordingly a member of a group consisting of: an electricity consumption of a group of the plurality of consumers, an electricity production of the group, an electricity demand of the group, a forecasted electricity consumption of the group, a forecasted electricity production of the group, a group of plurality of consumers having members with at least one of a common or accumulated consumption, a common production, a group of plurality of consumers having balance between consumption and production, and a forecasted electricity demand of the group, carbon footprint, carbon budget, credits, profiling of all criteria.

Optionally, the data analysis unit is configured for forwarding an outcome of the estimating to a power supplier so as to facilitate load management of the plurality of consumers.

Optionally, the analysis is a statistical analysis.

Optionally, the data analysis unit is configured for clustering the group according to a common characteristic.

Optionally, the data analysis unit is configured for forwarding the estimation to an ad server so as to allow providing at least one member of the group with a promotional content.

According to some embodiments of the present invention there is provided a method of estimating electric energy generation. The method comprises monitoring electric energy generation of each of a plurality of energy sources managed by a consumer connected to an electric grid, computing a forecast of a prospective electric energy generation based on the monitoring, and powering the electric grid according to the forecast.

Optionally, the method further comprises receiving a weather forecast and performing the computing according to the weather forecast.

Optionally, the method further comprises receiving statistical data pertaining to a plurality of consumers connected to the electric grid and performing the computing according to the statistical data.

Optionally, the managing comprises managing a profile documenting the consumption history of each the consumer.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volitile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of managing electric energy delivery and/or commerce, according to some embodiments of the present invention;

FIG. 2 is a block diagram of an exemplary electrometer for allowing a grid connected consumer to sell electricity and/or to purchase electricity from other grid connected consumer, according to some embodiments of the present invention;

FIG. 3 is a flowchart of a process generating a sell offer for electric energy consumption of a grid connected consumer, according to some embodiments of the present invention;

FIG. 4 is a flowchart of a process for generating a purchase offer for electric energy consumption by the grid connected consumer, according to some embodiments of the present invention;

FIG. 5 is a flowchart of a method of managing electric energy commerce, according to some embodiments of the present invention;

FIG. 6 is a process of charging an electric device, according to some embodiments of the present invention;

FIG. 7 is a process of charging electric storage cells, according to some embodiments of the present invention; and

FIG. 8 is a schematic illustration of the exemplary electrometer of FIG. 2 and a connection thereof to an electric switch, according to some embodiments of the present invention.

### DESCRIPTION OF EMBODIMENTS OF THE INVENTION

The present invention, in some embodiments thereof, relates to method and system for managing resources and, more particularly, but not exclusively, to method and system for managing power supply and consumption.

According to some embodiments of the present invention, there is provided methods and a system for managing the delivery and/or commerce of electric energy generated by a plurality of renewable energy sources, which are managed by electricity consumers, to an electric grid. The system allows implementing a rewarding process in which a consumer, managing one or more energy sources, posts one or more sell offers for electric energy supply and rewarded according to the acceptance of these sell offers. The system is based on a plurality of electricity commerce devices. Each electric commerce device optionally comprises one or more metering units for monitoring the consumption of the electricity consumer and the production of its renewable energy sources. Optionally, the sell offers are sent according to outputs registered by metering units. In some embodiments the electricity commerce devices are designed to post offers for purchasing electric energy from other consumers who manage renewable energy sources. The purchasing may be performed according to various variables, for example rates, estimated supply and demand, expected consumption and production and the like. As used herein, sell offers and purchase offers may be for Carbon credits.

According to some embodiments of the present invention, there is provided methods and an electric commerce device for charging energy cells, for example of stationary energy storages and/or of hybrid and/or electric vehicles according to supply and demand data. The system may manage the charging according to various measures and/or usage approximations.

According to some embodiments of the present invention, there is provided methods and a system for managing an electric energy delivery and/or commerce according to data pertaining to sell offers and purchase offers of consumers connected to a common electric grid.

According to some embodiments of the present invention, there is provided a network node, such as a server, for managing electric energy delivery and/or commerce by matching between sell offers for locally generated energy and purchase offers which are received from a plurality of consumers connected to a common electric grid. In such embodiments, a consumer that manages renewable energy sources can post sell offers for some or all of the energy they produce to other consumer who submits an offer that meets the sell offer's specifications.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

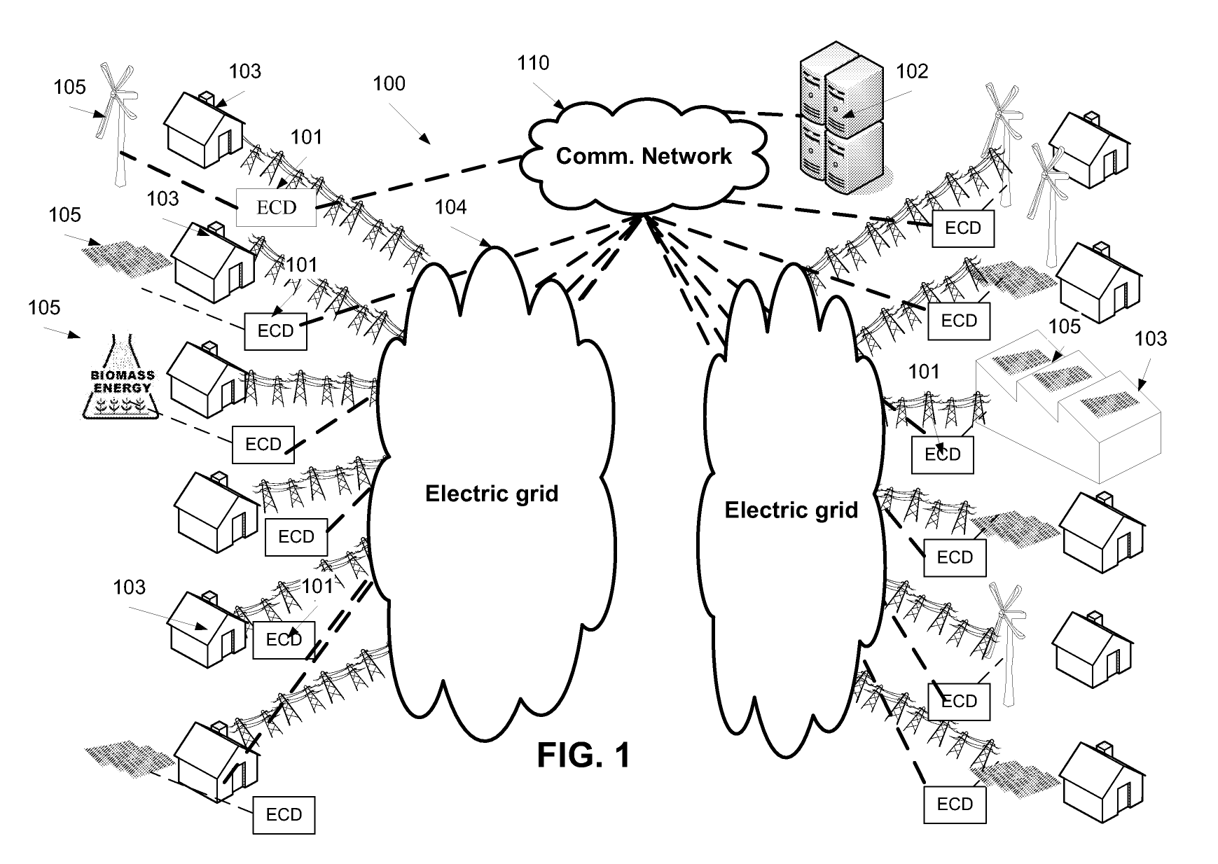

Reference is now made to FIG. 1, which is a schematic illustration of a system 100 of managing electric energy delivery and/or commerce, according to some embodiments of the present invention. The system 100 includes electricity commerce devices 101 which communicate either with an electricity commerce management unit 102, such as a network node, for example a central server, or among themselves, via communication network 110. Each electric commerce device 101 optionally includes one or more electrometers, such as smart electrometers, that monitor power delivered from a certain consumer 103 to an electric grid 104 and/or from the electric grid 104 to the local electric energy network of the consumer 103. Such a consumer may be referred to herein as a grid connected consumer 103. A grid connected consumer may be a household, a small business, for example a store, a small factory, a hotel, a motel, and/or any other electric energy consumer that is connected to the electric grid 104. The electric grid 104 may be a large electric energy mains, a segment of the large electric energy mains, an off the grid, such as the SMA™ Sunny Island™ grid, and/or any micro grids.

Optionally, the electricity commerce devices 101 use bi-directional meters for net metering. In such an embodiment, the electricity commerce devices 101 are connected between an inverter and the main switch of the grid connected consumer 103. Additionally or alternatively, some of the electricity commerce devices 101 include one or more unidirectional meters. Optionally, each electricity commerce device 101 includes two meters, one to measure electricity consumption, the other to measure electricity generation. For example, as commonly used in FIT infrastructures. In such an embodiment, the grid connected consumer 103 is connected to both meters.

Some electricity commerce devices 101 monitor electric energy that is locally generated by one or more renewable energy sources 105 which are managed by the certain grid connected consumer 103 they are related to. For example, a renewable energy source may be, but not limited to, a facility for harvesting Wind power, Water power, solar energy, Wastewater, biofuel, liquid biofuel, Solid biomass, Biogas, and/or Geothermal energy. Additionally or alternatively, the electricity commerce devices 101 monitor and manage the electric energy that the certain grid connected consumer 103 delivers to the electric grid 104 and/or to the local electric energy network of the managing grid connected consumer 103. It should be noted that though this document refers to management of renewable energy sources which are managed by grid connected consumers 103, non renewable energy sources which are managed by grid connected consumers 103, for example gas based generator, fuel based generator, biofuel generator, and/or any other small electricity generator which is locally managed by a grid connected consumer.

Each electric commerce device 101 may also include a smart monitor switch which controls the amount of electricity drawn from the electric grid 104 in order to allow such user to operate in three modes:

a self sustained mode the consumer 103 does not consume any outsourced power;

a grid mode—the consumer 103 gets all his power from the grid, regardless of its origin; and

a hybrid and/or intermediate mode—the user draws power from the grid 104 while, at the same time, generates stores and/or consumes power from the one or more renewable energy sources 105.

Optionally, each one of the electricity commerce devices 101 establishes a unidirectional or bidirectional communication with the electricity commerce management unit 102 and/or with one or more other electricity commerce devices 101. The communication is established through one or more communication networks 110, such as a wide area network (WAN), a local area network (LAN), a cell/pager network, such as a global system for mobile communications (GSM) and code division multiple access (CDMA), licensed radio networks, for example worldwide interoperability for microwave access (WIMAX) communication, combination licensed and unlicensed radio, and/or power line communication via the electric grid 104. The communication may be a fixed wireless network, a mesh network and/or a combination thereof. It should be noted that if the communication is based on power line communications, the electric grid 104 is used as the physical medium of the communication network 110.

The unidirectional or bidirectional communication allows the electricity commerce devices 101 to submit sell offers for the supply of electricity via the electricity grid 104 and purchase offers for consuming electricity via the electricity grid 104. As further described below, the system allows the consumers to sell and buy locally generated electricity for rates which are determined without a third party involvement.

In some embodiments of the present invention, purchase offers and/or sell offers are forwarded from one electric commerce device 101 to another without an intermediate such as the electricity commerce management unit 102. In such embodiments, sell offers may be sent to a group of potential grid connected consumers 103, optionally within a limit of a certain geographical diameter. Optionally, the group includes subscribers which are locally managed by the grid connected consumer 103 that places the sell offers.

Optionally, each grid connected consumer 103 has a management control unit that allows independent operation and management of the energy generation, consumption, and/or storage level. In addition, the grid connected consumer 103 may sell his output to a utility. The communication may be conducted by peer to peer (P2P) connections with other grid connected consumers 103, cloud server connections, and/or one or more server connections.

It should be noted that as the renewable energy sources 105 may not generate enough energy to meet the demand of all the grid connected consumers 103, one or more electricity providers, such as electrical companies, may deliver power to the electric grid 104. Furthermore, as the renewable energy sources 105 may include renewable energy sources, the reliability thereof depends on unpredicted resources and/or resources with low predictability, for example the availability and levels of sun irradiation and wind speeds. However, as each one of the electric commerce devices 101 may provide a local bidirectional metering, for example as further described below, electric energy generated by the renewable energy sources 105 may be distributed with reduced distribution loss since accurate real time generation data may be delivered to other consumers or management system 102 in order to match between the supply and the demand. The electric commerce devices also allow electrical companies, referred to herein as utilities, to meet peak and spike demands with less surplus or reserve energy levels by supplying real time data regarding each consumer's supply and demand. The utilities may use data pertaining to local energy consumption and production to reduce the generation of surplus energy.

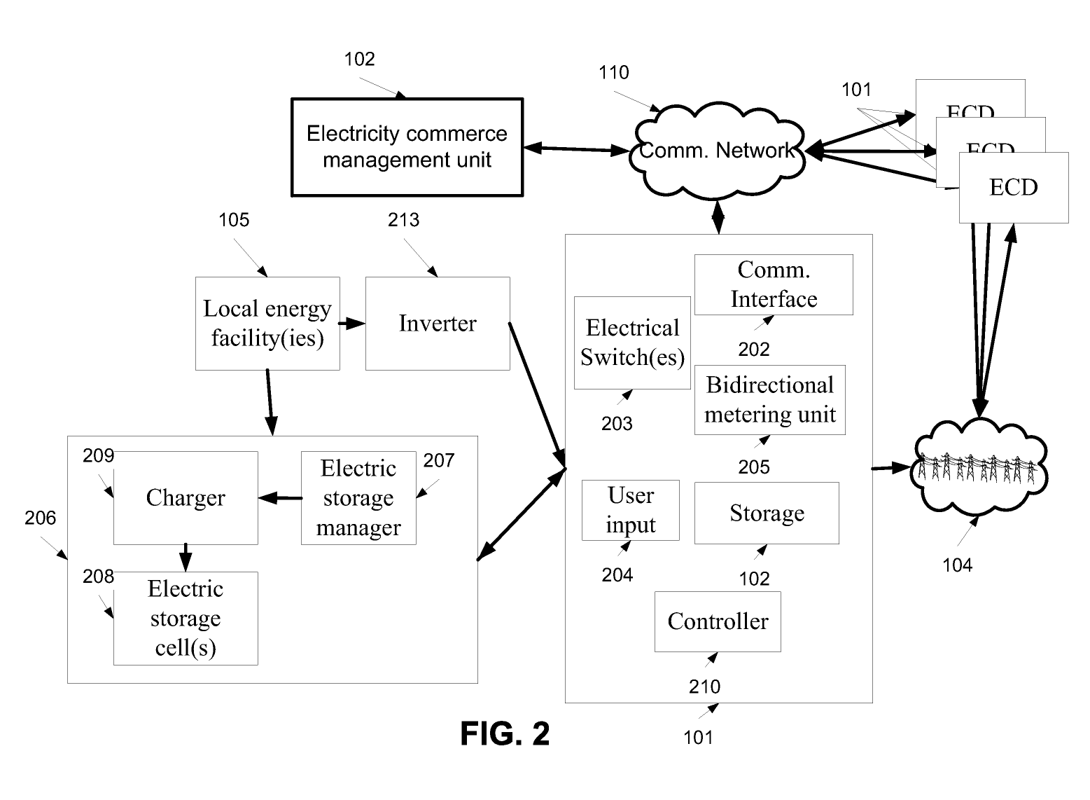

Reference is now also made to FIG. 2, which is a block diagram of an exemplary electric commerce device (ECD) 101 for allowing a grid connected consumer 103 to manage, monitor and control his energy generation, consumption and storage, sell electricity and/or to purchase electricity from other grid connected consumer 103 and/or utilities, according to some embodiments of the present invention. The exemplary electric commerce device 101 allows a respective grid connected consumer 103 to generate purchase offers and/or sell offers, for example as described below. The exemplary electric commerce device 101 includes a communication interface 202 to establish a connection with the electricity commerce management unit 102 via the communication network 110 and/or with other electric commerce devices 101. Optionally, the communication interface 202 may be used to establish a home area network (HAN) between the energy sources 105, storage solutions 206 and energy consuming appliances, including machine to machine (M2M) interfaces, inside the home or business. The communication interface 202 includes a cellular network gateway, such as a global system for mobile Communications (GSM) control panel, and/or wired and/or wireless Internet and/or Ethernet gateways for establishing packet based communication over the power lines and/or via cables, such as coaxial (COAX) cables, fiber optic cables and/or wirelessly, for example according to WiMax™ and/or Wi-Fi™ standards. The exemplary electric commerce device 101 further comprises a set of electrical switches, such as relay switches, for connecting and disconnecting power inflow and outflow between the electric commerce device 101, the electric grid 104, a local energy storage unit, for example as shown at 206, and one or more local renewable energy facilities 105. The exemplary electric commerce device 101 further comprises at least one unidirectional and bidirectional metering units 205 for metering the active power flow delivered from the electric grid 104 into the local electric energy network of the grid connected consumer 103 and from the one or more renewable energy sources 105 and storage solutions 206 into the electric grid 104.

In order to allow the delivery of electric energy that is generated by the local renewable energy facilities 105 to the electric grid 104, the exemplary electric commerce device 101 is optionally connected to an inverter 213 that converts direct current (DC) to alternating current (AC).

According to some embodiments of the present invention, the exemplary electric commerce device 101 includes an input unit 204, such as a man machine interface (MMI), for example a screen and a keyboard, a touch screen, a keypad, and the like. The MMI allows a local user, such as the owner and/or any other trustee pertaining to the grid connected consumer 103, to submit the aforementioned electric energy sell offers and/or purchase offers and/or to define rules for submitting automatically such electric energy sell offers and/or purchase offers. Optionally, the input unit 204 is an interface for receiving user inputs from a client terminal, such as a personal computer, a laptop, a Smartphone, and/or a personal digital assistant (PDA). In such embodiments, the user uses the client terminal for submitting the aforementioned electric energy sell offers and/or purchase offers and/or defining rules for automatically submitting such electric energy sell offers and/or purchase offers. Optionally, the client terminal hosts a module that presents a graphical user interface (GUI) that allows such a submission. Optionally the GUI is used for configuring the electric commerce device 101 and or to read data therefrom.

Optionally, the communication interface 202 is controlled by a controller 210 that manages the sell offers and/or purchase offers generation, reception, and/or transmission process, optionally according to the aforementioned rules. The controller 210 generates and initiates the transmission of sell offers and purchase offers. Optionally, the controller 210 places the sell offers and/or purchase offers according to a set of rules, for example the set of rules which are defined using the MMI 204 and/or a set of rules that is defined in advance. Optionally, the controller 210 is located on a remote server. Optionally, the controller 210 performs backup, logging and profiling that is maintained at the user level.

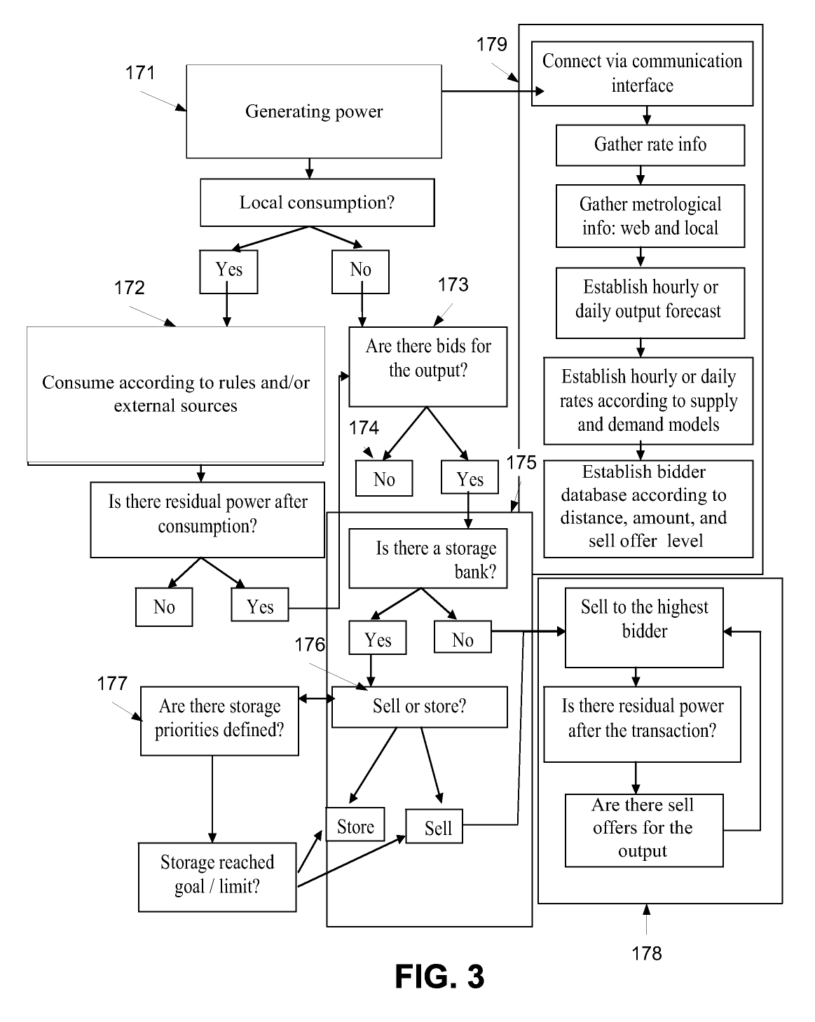

Reference is now made to FIG. 3, which is a flowchart of a process for generating a sell offer for electric energy consumption of the grid connected consumer 103, according to some embodiments of the present invention. The method is optionally managed by the controller 210.

First, as shown at 171, electric energy is generated by the renewable energy sources 105. If the electric energy is needed for local consumption, the consumption is performed according to the aforementioned rules and/or external sources, for example in response to an automated and/or peak demand response and/or various load management scenarios offered or dictated by utilities or energy authorities, for example as shown at 172. In such a manner, the local consumption is managed, optionally dynamically, according to user preferences and/or according to data gathered from external sources, for example a cost analysis and/or an arbitrage valuation model, and/or a carbon footprint and budget calculator, manager and considering carbon credits or any combination thereof.

If power is not needed for local consumption and/or if there is residual power, bids are generated and outputted, as shown at 173. Optionally, the bids are forwarded as bid messages defining a power supply rate and an allocated amount of power supply. Optionally, bids are generated according to a current and/or an estimated domestic consumption and/or production of the respective grid connected consumer 103 and/or according to variations in the consumption and/or generation rates. For example, energy may be directed for storage when the consumption rates are low and/or when a forecast for future local consumption that estimates a demand or a consumption at a rate higher than the current cost of the same amount of power. As shown at 179, the sell offers may be generated according to data gathered from external sources, such as current and/or forecasted rates, current and/or forecasted renewable energy related factors, such as weather and biomass and/or Biofuel supply, current and/or forecasted supply and demand patterns and the like.

Optionally, the controller 210 generates the sell offers according to an economic model that is dynamically updated according to changes in the rewarding rates, utility and/or other users' rates, supply and demand data, predictive consumption model, supplementary energy sources, such as energy storage and the like. Using such an economic model may take into account financial incentives, local generation delivery cap and/or amortization pertaining to the energy generation. Optionally, the controller 210 generates the sell offers according to load limitations, such as a prepaid budget and/or electric energy bill debits and/or credits. Optionally, the controller 210 generates the sell offers according to carbon emissions, carbon credits and/or allowance, such as a carbon budget and/or carbon cap.

Optionally, the controller 210 generates the sell offers according to current consumption of the respective grid connected consumer 103. In such a manner, unused energy is bided. It should be noted that purchase offers may be generated in a similar manner.

As shown at 175, if no offers to purchase the offered power are generated, for example if the provided external data suggests that the reward is lower than an estimated cost of the delivery of the electric energy, the process stops. Else, the electric energy is stored and/or delivered to the electric grid 104, an action which may be referred to as selling. Optionally, a forecast of local consumption at a rate, which is higher than the rate of storing currently available electric energy, may be considered if the one or more electric storage cells 208 are not full.

As depicted in FIG. 2, the exemplary electric commerce device 101 may be connected to a local energy storage unit 206. The local energy storage unit 206 optionally comprises an electric storage manager 207 to control, monitor and manage the charging of one or more electric storage cells 208, such as lead-acid batteries and lithium batteries, for example using a common electric charger 209.

In such embodiments, the decision whether to store or to sell locally generated electric energy, as shown at 176, may be determined according to priorities, as shown at 177, and/or according to data pertaining to domestic consumption and/or production of the respective grid connected consumer 103 and/or according to variations in the consumption and/or the production rates. For example, the electric storage manager 207 and/or the controller 210 may instruct charging when the consumption rates are low. Optionally, the electric storage manager 207 and/or the controller 210 is designed to manage switching between charging the electric storage cells 208 and delivering the stored energy to the electric grid 104 according to an arbitrage valuation model. In such embodiments, the consumption and/or production rates are constantly updated according to an external source, such as a server, for example via the communication network 110.

As shown at 178, the electric energy may be sold to the highest bidders. If the energy suffices for a number of grid connected consumers 103, the highest purchase offers for the sell offer wins. In addition, outputs may be sold partially to several purchasers in order to achieve maximal profit.

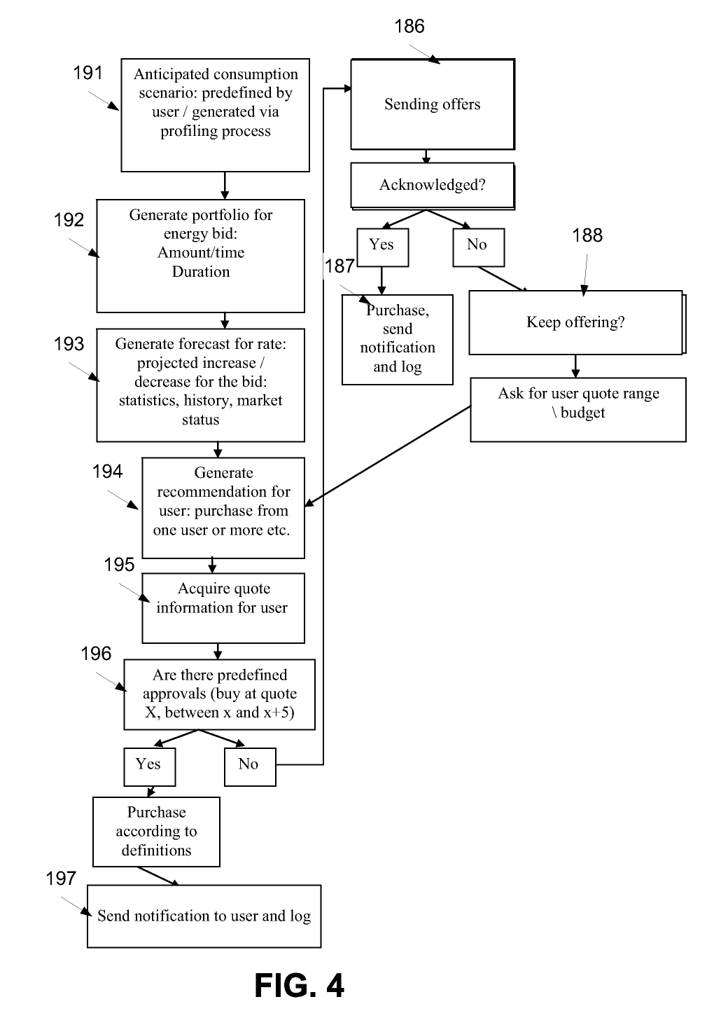

Reference is now made to FIG. 2 and to FIG. 4, which is a flowchart of a process for generating purchase offer for electric energy, according to some embodiments of the present invention.

First, as shown at 191, a consumption scenario is anticipated. The consumption scenario is optionally provided by the user, for example using the aforementioned user interface 204, and/or generated according to empirical and/or demographic data pertaining to the respective grid connected consumer 103 according to profiling processes maintained by the management unit.

Optionally, as shown at 192, a portfolio for purchase offers is generated. The portfolio defines a requested amount of electric energy, optionally estimated according to consumption scenario, and the rate the respective grid connected consumer 103 is ready to pay. The rate is provided by the user and/or calculated automatically according to the cost of purchasing electric energy from the utilities and/or other consumers.

Optionally, as shown at 193, the rate is calculated according to projected cost, statistical analysis and/or history of previous purchases of electric energy by the grid connected consumer 103 or by similar grid connected consumers 103, and/or based on estimated, evaluated and real time market status, as obtained from available sell and purchase offers as well as utility rates received via energy commerce device 101 and/or electricity commerce management unit 102. Optionally, as shown at 194, an electric energy purchase recommendation is generated and presented to the user. If the recommendation is approved, the purchase offer is either forwarded via the electricity commerce management unit 102 for acquiring sell offers from other grid connected consumer 103 and/or utilities, or directly between the grid connected consumers 103. In such a manner, as shown at 195, sell offer data is acquired.

Optionally, as shown at 196, predefined purchase instructions, for example stored instructions for purchasing electric energy from a certain grid connected consumer 103, electric energy is purchased, either by a match made by the electricity commerce management unit 102, as described below and/or according to an approval of the user. As shown at 197, the user is notified about the purchase and/or the purchase is logged for billing, budgetary and profiling purposes.

Optionally, if no predefined instructions are identified, as shown at 186, purchase offers are forwarded to a number of grid connected consumers 103 and/or utilities via the electricity commerce management unit 102 or directly. Optionally, the electric energy purchase offer is provided as a purchase message defining a power demand rate, a power demand amount, and optionally a power demand period. The rate amount, and/or the period of purchase offers are defined in values and/or ranges. The purchase offers, which are provided by each electric commerce device 101, are generated according to user inputs and/or automatically according to a pattern of domestic consumption and/or production of the respective grid connected consumer 103. The pattern may be a current pattern, and/or a dynamic and/or a statistic pattern based on data that is recorded during a period of few days, weeks, months, and years.

As shown at 187, if the purchase offers are acknowledged by grid connected consumers 103 and/or matched by the electricity commerce management unit 102, as described below, the electric energy is purchased. Else, as shown at 188, the offers remain active, optionally only after confirming with the user.

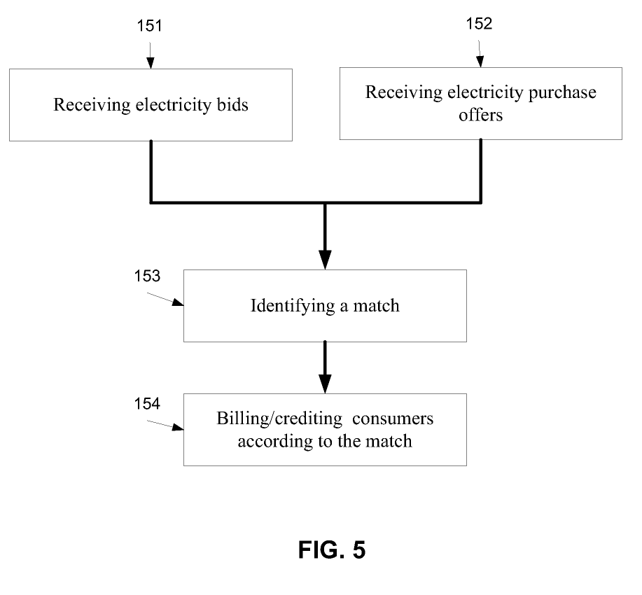

As described above, the electric energy commerce between the grid connected consumers 103 may be managed by the electricity commerce management unit 102 or directly and independently. Reference is now also made to FIG. 5, which is a flowchart of a method of managing electric energy delivery and/or commerce, according to some embodiments of the present invention.

First, as shown at 151, electric supply sell offers, which are generated by the electricity commerce devices 101 and forwarded via the communication network 110, are received by the electricity commerce management unit 102. Optionally, each electric supply sell offer is for a certain amount of power supply that is offered by one of the grid connected consumers 103. In such embodiments, each sell offer is provided as a sell offer message defining a power supply rate and an allocated amount of power supply. Optionally, the sell offer is generated similarly to the described in FIG. 3. Optionally, the sell offer message includes the period in which the grid connected consumer 103 renders the power supply available. Optionally, sell offers are conditioned. For example, a grid connected consumer 103 may condition the transmitting of a sell offer message in a reward rate, budgetary status and/or considerations, carbon footprint and/or credit, a charging status of electric storage cells, such as the electric storage cells 208 shown in FIG. 2 and the like.

Then, as shown at 152, one or more electric energy purchase offers are received, via the communication network 110, from some or all of the electricity commerce devices 101 by the electricity commerce management unit 102, P2P connections with one or more electricity commerce devices 101 and the like. Each electric energy purchase offer defines a power demand amount for a certain grid connected consumer 103. Optionally, the purchase offer is generated as depicted in FIG. 4. Optionally, the electric energy purchase offer is provided as a purchase message, for example as described above. In addition, offers may be presented in option like versions, such as put or call and other kinds and variations of future contracts or derivatives in order to offer freedom and flexibility to all users.

Now, as shown at 153, a match is identified between the purchase offers and the sell offers. As described above, each purchase offer reflects an estimated power supply demand and every sell offer reflects an estimated power production that is available for sell. These estimations may be used for evaluating current consumption among the grid connected consumers 103, separately and/or collectively. For example, a purchase offer for a daily consumption of 0.5 Kilo Watt (s) per hour (kWh) between 12:00 and 15:00 for up to 0.16 dollar per kWh may be matched with one or more sell offers having a total power availability that is in this price range. In another example, a sell offer for a daily output of 25 Kilo Watt (s) per hour (kWh) between 08:00 and 15:00 for more than 0.15 dollar per kWh may be matched with one or more purchase offers having a matching total demand for power that is purchased for compensation in this price range.

Now, as shown at 154, after matches between the purchase offers and the sell offers have been identified, related grid connected consumers are credited and/or debited according to the match. Optionally, the electricity commerce management unit 102 updates a billing unit, such as a billing server, according to the matches. The accounts of the grid connected consumers 103 may now be credited or debited according to matches.

Optionally, the electricity commerce management unit 102 and/or the electric commerce device 101 manages the matching between sell offers and purchase offers in a manner that reduces distribution loss, for example by taking into account distances between grid connected consumers 103.

According to some embodiments of the present invention, the matches constitute binding agreements in which the seller(s) placing the sell offer(s) undertake to provide the bided energy and the buyer(s) placing the purchase offer(s) undertake to purchase the energy according to the submitted purchase offer terms. Such matching allows a first grid connected consumer 103 that has energy generation facilities 105, such as PV arrays and wind turbines, to sell energy, which is generated for example during the morning, to a second grid connected consumer 103, for example her neighbor, that consumes energy for the operation of air conditioning, computing, lights, and the like.

Optionally, data pertaining to the match, supply and demand, amounts of loads, their timings and/or the billing/crediting of customers is forwarded to a utility or an authority entity for automated demand response, peak management or emergency scenarios instructions.

The match allows the first grid connected consumer 103 to receive a reward for the energy that is generated by her energy facilities 105 and the second grid connected consumer 103 to purchase power at a rate that is optionally lower than the rate of power consumed from another consumer or an electric company, also referred to herein as a utility.

Optionally, the matching is performed with respect to the distance between selling and buying grid connected consumers 103. Optionally, sell offers for electric energy from a certain renewable energy source 105 are set to be matched, and/or to be matched in a higher probability with purchase offers from grid connected consumers 103 which are closer to the certain renewable energy source 105. In such a manner, the related distribution loss is reduced. Optionally, a match is performed only if the distance is below a certain distance. It should be noted that such a matching allows reducing the total distribution loss of power over the electric grid 104. The electric energy that a certain consumer receives from the utility has a distribution loss that is higher than the distribution loss of the electric energy it receives from a selling consumer that delivers electric energy at a closer location thereto, considering the transmissions between high, medium and/or low voltages which is common in electricity distribution from remote centralized locations to end users.

According to some embodiments of the present invention, the controller 210 places the sell offers and purchase offers in real time. As used herein, real time means the time that it takes a process to occur, for example while an inflow of electric energy is consumed by the respective grid connected consumer 103 from the electric grid 104. For example, the controller 210 constantly places purchase offers at the electricity commerce management unit 102 for cheaper sell offers and/or searches the electricity commerce management unit 102 for cheaper sell offers. In another embodiment, the controller 210 gradually reduces a price of an unmatched sell offer. Optionally, the reduction is adjusted according to changes in the tariff of electric energy of the utilities, the data obtained regarding matched purchase and sell offers by other grid connected consumers 103, the charging status of the cells of the respective grid connected consumer 103, the local current and forecasted consumption patterns of the grid connected consumer 103, and the like.

Optionally, the system 100 is implemented in a limited area, such as an apartment building and/or complex, an office building and/or complex, a set of apartment buildings, commercial and/or industrial parks, and/or any other area in which one or more grid connected consumers 103 maintain certain renewable energy sources 105 and others have a demand for energy and/or storage solutions.

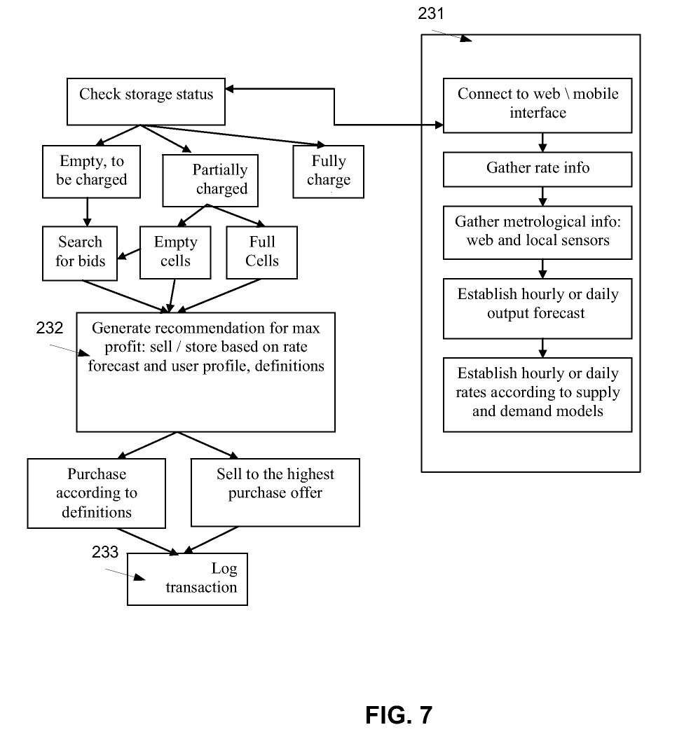

Reference is now made, once again, to FIG. 2. Reference is also made to FIG. 7, which is a process of charging one or more electric storage cells 208, according to some embodiments of the present invention. In FIG. 7, the data gathered by the electric commerce device 101 is used for adjusting the charging patterns of the storage unit. Optionally, the electric storage manager 207 switches between active power sources, for example allow the grid connected consumer 103 to utilize the stored electric energy when the consumption rates are high. Optionally, the charging and/or utilization schemes are determined according to estimated future consumption and/or generation, for example a forecasted load of a customer in a certain day of the week and/or forecasted electric energy generation of the renewable energy sources 105 of the respective grid connected consumer 103, for instance an estimated solar energy generation may be determined according to the weather forecast and/or local generation history. Optionally, forecasts from exterior sources such as the internet may be downloaded and compared against statistical data, real time sensor data, for example irradiation and wind sensors, and/or the current time and season. Such a comparison allows outputting a robust forecast.

For example, as shown at 231 of FIG. 7, the storage evaluation is based on external data pertaining to the rate of consumed electric energy. In such a manner, as shown at 232, the charging is performed to reduce electric energy cost and optionally increase the revenue that is gained from the delivery or distribution of electric energy to the electric grid 104. Optionally, the electric storage manager 207 manages the charging of the one or more electric storage cells 208 according to the management unit which establishes the rate that is defined in available sell offers and purchase offers. In such embodiments, the storage cells are charged with power from the electric grid 104 if the rate is lower than the rate of the utilities which are connected to the grid. The consumer has anticipated consumption data that allows forecasting purchase rates increments. In such a manner, the customer may profit from electricity rate arbitrage, for example by charging the storage cells and selling the stored electricity later on at higher rates. Optionally, the electric storage manager 207 amortizes the battery cycle cost. Optionally, the electric storage manager 207 logs the charging, for example as shown at 233. Optionally, the electric storage manager 207 interoperates with the electricity commerce device 101 that conducts the activities as shown at 231.

Optionally, the electric storage manager 207 dynamically updates charging and/or utilization schemes to allow rotation of the electric storage cells 208 so as to maintain similar levels of degradation. In such embodiments, voltages and currents are monitored per battery in order to evaluate its condition and performance. Optionally, charging cycles are logged per cell in order to use the sets in an optimal manner.

According to some embodiments of the present invention, the electrometers gather data pertaining to electric energy consumption and production and forward the data to allow empirical analysis. In such embodiments, the total production of the renewable energy facilities 105 of the grid is calculated, for example for determining the scale production, the residential production, and/or the commercial production of a utility. Optionally, the controller 210 calculates, for example according to outputs of the bidirectional metering unit 205, the total consumption of the grid connected consumer 103. Optionally, the data is forwarded, using the communication interface 202, to the electricity commerce management unit 102. Optionally, the electricity commerce management unit 102 calculates based thereupon supply and demand at a limited scale level, for example at the area near the grid connected consumer 103. Optionally, the electricity commerce management unit 102 calculates accordingly patterns that portray the generation patterns, consumption habits and the consumption timings of the grid connected consumer 103. In such a manner, sell offers and/or purchase offers may be generated in low and high consumption periods in consideration of real time and historical data.

Optionally, the electricity commerce management unit 102 may be used to detect groups of grid connected consumers 103 that have selected characteristics, for example a common production level, a common consumption level, and/or a balance between consumption and production.

Optionally, the electricity commerce management unit 102 may be used to interoperate with centralized and supervisory control and data acquisition (SCADA) systems to enable automated and real time demand response programs, load management and emergency scenarios.

The generation of sell offers and purchase offers may be affected by the characteristics of the local renewable energy facilities 105. For example, the controller 202 of a respective grid connected consumer 103 that manages a PV energy generation facility may generate purchase offers to buy power from a grid connected consumer 103 that sells power from a wind turbine at night when PV generation is decommissioned and total demands are low, therefore rates would be low. Optionally, the purchase offer has a maximum rate per kWh, which is dynamically adjusted according to the rate per kWh for electric energy provided from one or more utilities and other consumers 103 that power the electric grid. In such embodiments, if a sell offer for power at a rate that is equal to or lower than the rate of the one or more utilities and other consumers 103 is available, it is matched with the purchase offer. Else, the respective grid connected consumer 103 is charged for the rate of the one or more of the utilities that powers the grid, optionally the cheapest one or proportionately the cheapest one.

Optionally, a number of electric grids 104 may be connected to a common electricity commerce management unit 102. Optionally, a number of electric energy commerce management units, such as 102, may be connected to create a network of electric energy commerce management units 102. In such a manner, data gathered from one electric grid 104 may be used as reference to another electric grid 104 and vice versa.

Additionally or alternatively, the sell offers and purchase offers, and/or the matches may be used for estimating the load that is required to some or all of the grid connected consumers 103. As the energy that is provided by the renewable energy sources 105 may not be sufficient to meet the demand of all of the grid connected consumers 103, the utility may still power the electric grid 104. In such embodiments, the sell offers and purchase offers, and/or the matches may be used for estimating the total load that is required meet the demand. The sell offers and purchase offers reflect actual and current supply and demand data and therefore can be used for estimating reduction, cessation and/or incline in the power consumption. Optionally, the power that is provided to the electric grid 104 is adjusted according to the estimated load. In such a manner surplus generation of electrical power may be avoided or reduced as the amount of power that is delivered to the electric grid 104 and dynamically adjusted according to consumption and distributed generation patterns which are based on actual and forecasted supply and demand data.

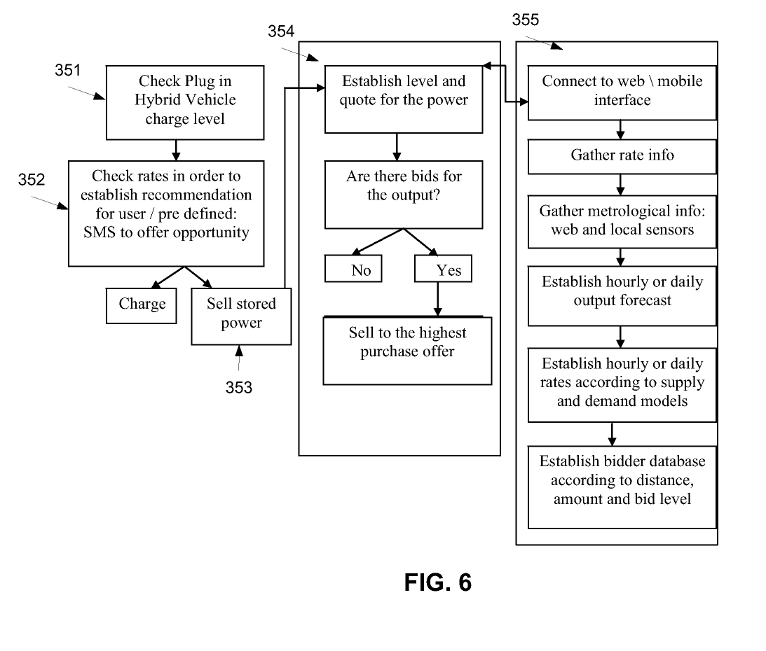

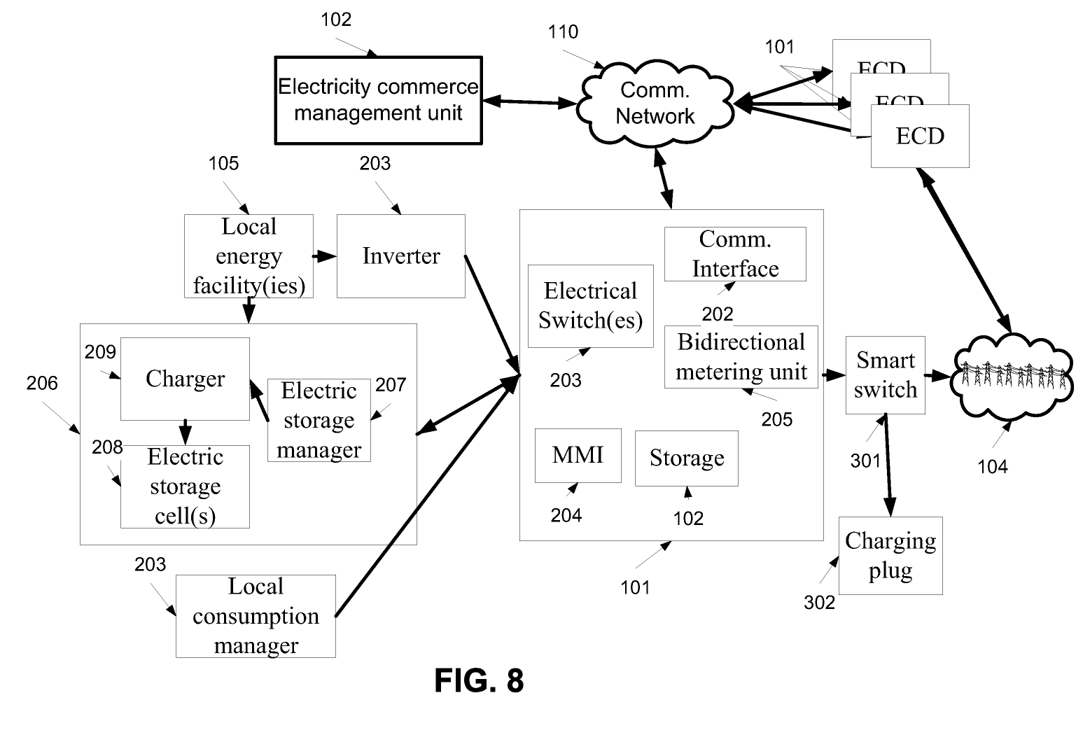

Reference is now made to FIG. 8, which is a schematic illustration of the exemplary electric commerce device 101 of FIG. 2 and a connection thereof to an electric switch 301, for example as shown in FIG. 8, according to some embodiments of the present invention. Reference is also made to FIG. 6, which is a flowchart of an exemplary process of charging a hybrid and/or electric vehicle, according to some embodiments of the present invention. The bidirectional electric switch 301 switches between a number of power delivery paths delivered via the electric commerce device 101, for example between a delivery path leading to the electric grid 104 and another delivery path leading to the storage solution 206 or the local energy facility 105 or one or more charging plugs 302, such as charging sockets of an electric and/or a hybrid device and/or system, for example an electric and/or a hybrid car. In such embodiments, the power generated by the renewable energy sources 105 of the respective grid connected consumer 103 may be directly used for charging electric and/or hybrid cars. Optionally, the bidirectional electric switch 301 and/or the electrical switches 203 are set to allocate power to the one or more charging plugs 302 according to one or more rules, for example throughout the day or night in order to charge a vehicle and/or a device at predetermined and/or optimal times considering cost and/or profit as well as demand related timing. In addition, the electric and/or hybrid vehicle may be used as a storage cell.

As shown at 351 of FIG. 6, the charging plugs 302 identify the plugging of a device, such as a vehicle thereto. Then, as shown at 352, the rates for charging the connected vehicle are identified, for example by accessing external sources, as described above. Optionally, the user is notified of the rate, for example by receiving an email, a short message service (SMS) or an instant message (IM). In such embodiments the communication interface 202 forwards the data to an Email, SMS and/or an IM service. If the user approves and/or if the charging patterns are predefined according to a set of fulfilled charging rules, the vehicle is charged. Else, as shown at 353, the power is delivered to the electric grid 104. Optionally, as shown at 354, the delivery is performed as described above, for example sold to the highest offer. Optionally, as shown at 355, the transaction is performed according to a rate that is determined according to data acquired from external sources, as described above.

Optionally, as shown at FIG. 8, the one or more charging plugs 302 and the electric switch 301 are bidirectional, allowing using the electric storage cells of the device and/or vehicle that is connected thereto as an energy source. In such embodiments, a battery of a hybrid and/or electric vehicle may be used for powering the local electric energy network of a grid connected consumer 103, and vice versa. Optionally, electricity may be drawn from the electric or hybrid vehicle in order to sell it at a higher rate than the estimated rate in which it is charged later on.

Optionally, electricity may be drawn from the electric or hybrid vehicle in order to reply to demand response and load management programs initiated by a utility or an authority.

According to some embodiments of the present invention, the electricity commerce management unit 102 is used to gather supply and demand data pertaining to the grid connected consumers 103 and performing an empirical analysis, such as a statistical analysis, of the data. Additionally or alternatively, each one of the electric commerce devices 101 is used to gather supply and demand data pertaining to the grid connected consumer 103 which is associated therewith and performing an empirical analysis, such as a statistical analysis, of the data. Optionally, each electric commerce device 101 transmits data that is monitored by the bidirectional metering unit 205, for example local electric energy inflow and outflow, to the electricity commerce management unit 102. The data is optionally tagged with an identification (ID) tag, for example a client number. The ID tag allows the electricity commerce management unit 102 to cluster data according to various characteristics of the grid connected consumers 103, for example according to the geographic location or any other demographic segment. For example, the generation and/or the supply and demand in a certain street or neighborhood may be estimated according to the data received via the communication network 100, optionally in a certain hour of the day, the time of the year and the like.

Optionally, the electricity commerce management unit 102 and/or electric commerce device 101 converts the data gathered from the consumers into IP and transmits it onto a utility or electrical authority.

Optionally, the electric commerce device 101 is connected to one or more smart thermostats and/or other consumption managers that control and manage electricity consumptions of certain appliances. In such a manner, the local and/or estimated consummation may be managed according to the scheduled and/or statistical analysis of the thermostats and/or other consumption managers in order to reduce overall costs and emissions and confirm with demand response and load management programs.

Optionally, the electricity commerce management unit 102 and/or electric commerce device 101 is connected to an advertisement (ad) server. In such embodiments, the ad server may profile grid connected consumers 103 and forward targeted advertisements thereto for example according to a relation to a cluster of grid connected consumers 103 having common statistical, geographical, and/or meteorological characteristics, a common energy production and/or a common energy production estimation. Optionally, the ad server forwards targeted advertisements according to the consumer's profile and/or variations in the consumption and/or the generation. For example, if the grid connected consumers 103 has a below expected outflow and/or above expected inflow, ads including recommendation and/or tips may be delivered thereto such as recommendation to clean his PV array due to unexplained decrease in generation or adjust his PV array in accordance with seasonal variations in the sun's trajectory. Such ads may be sent automatically and/or according to an operator request, for example to opt-out users, optionally according to privacy preferences.

Additionally or alternatively, the electricity commerce management unit 102 and/or electric commerce device 101 generates one or more performance profiles for some or all the grid connected consumers 103. These performance profiles allow evaluating, identifying and/or diagnosing malfunctions and/or decreased performance of renewable energy sources 105, s for example decreased performance of a PV array, for example decreased performance which has been caused by misalignment, shading, dirt and/or dust.

Optionally, a grid connected consumer 103 may establish a long term and/or reoccurring relationships with one or more other grid connected consumer 103 for the purpose the energy consumption and/or production exchange. Optionally, energy storage means, for example batteries and/or capacitors, are used for storing electricity between the time the instance the electricity generation begins and an execution of a transaction.

Optionally, the electricity commerce management unit 102 and/or electric commerce device 101 is used for managing trading carbon credits respectively among the grid connected consumers 103 and/or of the electric commerce device 101 which is associated therewith in a similar manner to the aforementioned electricity commerce.

It is expected that during the life of a patent maturing from this application many relevant systems and methods will be developed and the scope of the terms a network, a client terminal, a server, an electric grid and communication is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of billing electric energy commerce, comprising:
a) providing a plurality of power sell offers of a plurality of first consumers each connected to an electric grid;
b) providing a power purchase offer of a second consumer connected to said electric grid;
c) selecting at least one of said plurality of sell offers of at least one of said plurality of first consumers according to said power purchase offer; and
d) billing said second consumer according to said at least one selected sell offer so as to allow crediting said at least one first consumer.

2. The method of claim 1, further comprising estimating a distance said second consumer and each said first consumer and performing said selecting according to said distance.

3. The method of claim 1, wherein said plurality of power sell offers and said power purchase offer are received as network messages sent over a communication network from said plurality of first consumers and said second consumers, said selecting being performed by at least one of a central network node connected to said network, at least one of said plurality of first and second consumers.

4. The method of claim 1, wherein said each said power supply offer defines a first set of variables comprising a power supply rate, a power supply amount, and a power supply period, said power purchase offer defining a second set of variables comprising a power demand rate, a power demand amount, and a power demand period, said selecting being performed by respectively matching said first and second sets of variables.

5. The method of claim 1, wherein said power purchase offer is for a future consumption of electric energy.

6. The method of claim 1, wherein at least one of said plurality of power sell offers is for a future consumption of electric energy.

7. The method of claim 1, further comprising profiling at least one of electricity generation, electricity consumption and electricity storage of at least one of said plurality of first consumers.

8. The method of claim 1, wherein said selecting further comprises selecting between said plurality of sell offers and at least one utility, said billing being performed according to said selecting.

9. The method of claim 1, wherein said selecting is performed according to a rate defined in each said power supply sell offer, said a)-c) being repeatedly performed so as to reduce an average rate of said at least one selected sell offer.

10. The method of claim 1, wherein at least one of said power purchase offer and said power sell offers of at least one of said first and second consumers includes a carbon credit, said selecting comprising trading said carbon credit.

11. A method of delivering electric energy, comprising:
generating electric energy using at least one energy source managed by a consumer connected to an electric grid;
calculating the amount of energy which is forecasted to be generated in a period of time;
calculating a rate for selling said electric energy to another consumer or utility connected to said electric grid;
receiving a purchase offer for said electric energy; and
selecting between local consumption of said electric energy by said consumer and a delivery of said electric energy to said electric grid according to said purchase offer.

12. The method of claim 11, wherein said local consumption comprises at least one of charging at least one energy cell, charging a car, and powering a local electric energy network of said consumer.

13. The method of claim 11, wherein said calculating comprises creating at least one power supply sell offer for at least a portion of the electric energy according to said rate and receiving said purchase offer in response to said at least one power supply sell offer.

14. The method of claim 13, wherein said creating comprises forwarding said at least one power supply sell offer to at least one of said another consumer and a utility.

15. The method of claim 11, further comprising presenting said purchase offer to a user and receiving a user reaction in response, and performing said selecting according to said user reaction.

16. The method of claim 11, further comprising crediting said consumer for said electric energy according to said rate.

17. The method of claim 11, wherein said calculating is performed according to metrological and/or weather estimation.

18. An electric commerce device connected to an electric grid, comprising:
A metering unit for metering electric energy generated by at least one renewable energy source managed by a consumer connected to an electric grid;
a controller for generating at least one power supply sell offer for at least a portion of said electric energy;
a communication interface for forwarding said at least one power supply sell offer and receiving a reaction thereto; and
at least one switch for delivering said portion to said electric grid according to said reaction.

19. The electric commerce device of claim 18, wherein said controller is configured for analyzing said reaction and instructing said at least one switch to perform said delivering accordingly.

20. The electric commerce device of claim 18, further comprising a user interface for allowing a user to define said at least one power supply sell offer.

21. The electric commerce device of claim 18, wherein said controller receives at least one member of a group consisting of a weather estimation, an energy power supply estimation, an energy power demand estimation, a forecasted renewable energy related factor, a set of rules, a projected cost of said delivery, a statistical analysis, a history of previous purchases of electric energy, a current energy rate, a forecasted energy rate, an actual consumption of said consumer, and an estimated consumption of said consumer, an actual carbon footprint of the said consumer, an estimated carbon footprint of the said, a budget for consumption, a pre-payment option.

22. The electric commerce device of claim 18, further comprising at least one energy storage cell connected to said at least one switch, wherein said controller is configured for instructing said at least one switch to charge or discharge said at least one energy cell according to said reaction.

23. The electric commerce device of claim 18, further comprising at least one charging plug connected to said at least one switch and configured for being in an electrical connection with a rechargeable apparatus, wherein said controller is configured for instructing said at least one switch to power said charging plug according to said reaction so as to allow charging said rechargeable apparatus.

24. The electric commerce device of claim 23, wherein said controller is configured for instructing said charging plug to receive charged electricity from said rechargeable apparatus according to said reaction.

25. A system of billing electric energy consumption, comprising:
a communication interface for receiving a plurality of power sell offers and power purchase offers from a plurality of consumers connected to an electric grid;
a matching unit configured for identifying at least one match between at least one of said plurality of power purchase offers and at least one of said plurality of power sell offers; and
a billing unit for billing said plurality of consumers according to said at least one match.

26. The system of claim 25, further comprising a communications interface for transmitting data pertaining to said match to a power supplier.

27. A system of billing electric energy commerce, comprising:
a plurality of electricity commerce devices each having a metering unit for outputting a measurement of at least one of electric energy production and electric energy consumption of one of a plurality of consumers, said plurality of electricity commerce devices being configured for generating a plurality of power sell offers and power purchase offers each according to a respective said measurement and forwarding said plurality of power sell offers and power purchase offers among one another over a communication network; and
a billing unit for billing and crediting said plurality of consumers according to acceptance of said plurality of power sell offers and power purchase offers by at least one of said plurality of consumers.

28. The system of claim 27, further comprising a data analysis unit for analyzing said plurality of power sell offers and power purchase offers and estimating accordingly a member of a group consisting of: an electricity consumption of a group of said plurality of consumers, an electricity production of said group, an electricity demand of said group, a forecasted electricity consumption of said group, a forecasted electricity production of said group, a group of plurality of consumers having members with at least one of a common or accumulated consumption, a common production, a group of plurality of consumers having balance between consumption and production, and a forecasted electricity demand of said group, carbon footprint, carbon budget, credits, profiling of all criteria.

29. The system of claim 28, wherein said data analysis unit is configured for forwarding an outcome of said estimating to a power supplier so as to facilitate load management of said plurality of consumers.

30. The system of claim 28, wherein said analysis is a statistical analysis.

31. The system of claim 28, wherein said data analysis unit is configured for clustering said group according to a common characteristic.

32. The system of claim 28, wherein said data analysis unit is configured for forwarding said estimation to an ad server so as to allow providing at least one member of said group with a promotional content.

33. A method of estimating electric energy generation, comprising:
monitoring electric energy generation of each of a plurality of energy sources managed by a consumer connected to an electric grid;
computing a forecast of a prospective electric energy generation based on said monitoring; and
powering said electric grid according to said forecast.

34. The method of claim 33, further comprising receiving a weather forecast and performing said computing according to said weather forecast.

35. The method of claim 33, further comprising receiving statistical data pertaining to a plurality of consumers connected to said electric grid and performing said computing according to said statistical data.

36. The method of claim 33, wherein said managing comprises managing a profile documenting the consumption history of each said consumer.
